(19) United States
(12) Patent Application Publication
(10) Pub. No.: US 2022/0058582 A1
(43) Pub. Date: Feb. 24, 2022

(54) TECHNICAL SPECIFICATION DEPLOYMENT SOLUTION

(71) Applicant: SMB Suite, Inc., Irving, TX (US)

(72) Inventor: David Greer, Irving, TX (US)

(21) Appl. No.: 17/350,779

(22) Filed: Jun. 17, 2021

Related U.S. Application Data
(63) Continuation-in-part of application No. 16/996,384, filed on Aug. 18, 2020, now abandoned.

(51) Int. Cl. G06Q 10/10; G06F 8/61; G06N 5/02

(52) U.S. Cl. CPC G06Q 10/101; G06N 5/02; G06F 8/61

(57) ABSTRACT

In one aspect, the present disclosure relates to a processing unit coupled to a memory storage, the processing unit being operative to receive at least one user selection from at least one of a plurality of preconfigured specification parameters, identify at least one resource based on the received at least one user selection, generate at least one deployment rule comprising: customizing of at least one user selection of the plurality of preconfigured specification parameters, customizing of at least one of a deployment cost analysis, and providing a deployment strategy to the user, generate a technical specification, the technical specification comprising at least one technical requirement defined by the following: the at least one user selection of the plurality of preconfigured specification parameters, and the at least one deployment rule, generate the deployment cost analysis of the technical specification, and deploy the technical specification comprising the at least one technical requirement.

### RELATED APPLICATION

This application is a Continuation-in-Part of U.S. application Ser. No. 16/996,384 filed Aug. 18, 2020, which is hereby incorporated by reference herein in its entirety.

It is intended that the above-referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to assembling, deploying, and maintaining computer systems and technical infrastructure.

### BACKGROUND

Assembling, deploying, and maintaining technical infrastructure is often challenging because it is difficult to generate, track, and allocate resources for providing desired deliverables. The assembly stage often includes, for example, generating a plan and generating a list of materials and labor that are needed for a technical specification. Following an information technology (“IT”) deployment, the installers may provide technical support for the client, which may include, for example, software and hardware updates, training, and other tasks that should be allocated and managed throughout all stages of the deployment.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In one aspect, the present disclosure relates to a system comprising: a memory storage communicatively coupled with a processing unit; and the processing unit coupled to the memory storage, the processing unit being operative to perform the following: receive at least one user selection from at least one of the following: at least one of a plurality of preconfigured specification parameters, and a grouping of the plurality of preconfigured specification parameters, identify at least one resource based on the received at least one user selection, the at least one resource comprising at least one of the following: software information, license information, service provider information, technical components, and implementation parameters, generate at least one deployment rule, the at least one deployment rule comprising: customizing of at least one user selection of the plurality of preconfigured specification parameters, customizing of at least one of a deployment cost analysis, and providing a deployment strategy to the user, generate a technical specification, the technical specification comprising at least one technical requirement defined by the following: the at least one user selection of the plurality of preconfigured specification parameters, and the at least one deployment rule, wherein the at least one technical requirement comprises at least one of the following: a temporal parameter, a resource projection, a machine activity, and a software activity, generate the deployment cost analysis of the technical specification, and deploy the technical specification comprising the at least one technical requirement, wherein the generating of the technical specification comprises processing the at least one user selection via applying each of the at least one deployment rule to each of the at least one user selection.

In another aspect, the present disclosure relates to a method comprising: receiving at least one user selection of at least one of the following: at least one of a plurality of preconfigured specification parameters, and a grouping of the plurality of preconfigured specification parameters; identifying at least one resource based on the received at least one user selection, the at least one resource comprising at least one of the following: software information, license information, service provider information, technical components, and implementation parameters, generating at least one deployment rule comprising: customizing of at least one user selection of the plurality of preconfigured specification parameters, customizing of at least one of a deployment cost analysis, and providing a deployment strategy to the user; generating a technical specification, the technical specification comprising at least one technical requirement defined by the following: the at least one user selection of the plurality of preconfigured specification parameters, and the at least one deployment rule, wherein the at least one technical requirement comprises at least one of the following: a temporal parameter, a resource projection, a machine activity, and a software activity, generating the deployment cost analysis of the technical specification, and deploying the technical specification comprising the at least one technical requirement, wherein generating the technical specification comprises processing the at least one user selection via applying each of the at least one deployment rule to each of the at least one user selection.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 illustrates a block diagram of an example method performed by the computing device of FIG. 12;

FIG. 3 illustrates a plurality of object types that may be employed by a platform;

FIG. 4 illustrates an example user interface to select from a plurality of products;

FIG. 5 illustrates a user interface that is operative to provide details about a product;

FIG. 6 illustrates an example of a user interface;

FIG. 7 illustrates an embodiment of a generated technical specification;

FIG. 8 illustrates an example of a change log;

FIG. 9 illustrates an example of a technical specification;

FIG. 10 illustrates a user interface specifying the various aspects of a technical specification;

FIG. 11 illustrates an example of a user interface displaying account information;

FIG. 12 illustrates an example of a flow diagram of an example method; and

FIG. 13 illustrates an example of computing device.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of information technology related to assembling, deploying, and maintaining technical infrastructure, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

Embodiments of the present disclosure provide a Deliverables Management System, referred to as the DMS. A first notable aspect of the DMS enables an institution, such as an Information Technology (“IT”) firm, to manage the life-cycle of its deployment systems through use of “Resource Distribution Modules” (RDM). The RDM may contain the blueprints and/or resources for the required activities (including, but not limited to, automated machine activities, administrative activities, customer activities, and billing activities) associated with the proposed technical specification infrastructure: from provisioning to maintenance at least one or more life cycle stages of the deliverables.

Accordingly, the selection of one or more RDMs may enable the formation of a DMS deployment (also referred to as an “offering”). An administrative user may select itemized RDM's and group them together to form the basis of a technical specification. The deployment of the technical specification, which may be determined via the selection of a plurality of RDMs to be analyzed by the DMS, may comprise, but not be limited to: product/service modules, hourly requirements and costs, licenses, technical components (e.g., cloud components, production components, and/or computing components), and sub-groupings of additional features.

The processing of the combination of RDMs (Technical Specification or Offering) is governed by a Rules and Mapping Engine (“RME”). The RME may be configured to read the relevant RDMs and assess how to properly, and within defined parameters and standards, map the deployment life-cycle of the technical specification into modules and activities. RDMs may exist as prepackaged templates for standardized technical specifications. The user may customize the RDMs within the templates associated with the technical specification, provided that the customizations do not exceed the restrictions and limitations supervised by the RME. In this way, RDMs are grouped together to formulate an acceptable result that is in accordance with administrative parameters, value generation, and quality control standards. Furthermore, the RME may be configured to allocate the necessary resources for the completion of the deployment of the technical specification, and assign those resources to the various stages during deployment of the technical specification. In this way, the RDMs can be used to enable the DMS platform to serve as a tool to oversee and monitor the deployment of the technical specification.

Having established the blue-prints and/or resources of the technical specification within a RDM—the deployment of the technical specification can now be fully standardized and rolled out from the moment of their formulation at the Customer Discovery stage. The RME may be configured to spec out the entire set of stages and activities in accordance to a DMS platform protocol. Throughout this process, additional RDMs may be interjected for updates or additions of potential technical specifications. Moreover, the RDMs may be custom tailored, with track-changes functionality for quality review, to ensure the technical specification meets the customer's needs. In turn, the DMS platform may additionally provide an interface by which a customer may review, agree, engage in financial transaction, and approve/sign off work-product at the various stages of the technical specification. Again, these elements are pre-defined upon the processing, analysis, and mapping of the RDMs into the DMS system to determine potential technical specifications.

Moreover, the RME may process each RDM in the technical specification to map out costs, hardware requirements, software licenses, deployment/configuration parameters, and actions necessary to complete the execution of the technical specification. This process may progress in discrete stages beginning with the generation of technical specification requirements, pass towards the Provisioning, Configuration and deployment stage, and end at the Support, Maintenance, and Upgrade components.

In this way, the RDM may serve as the fundamental unit of the DMS, and contains all of the elements necessary for the technical specification, deployment, and fulfillment, in its entire life-cycle. Thus, the RDMs may act as the “DNA” of the DMS and/or may offer a specific prepackaged data element that allows the RME to fulfill and execute the technical specification of the DMS.

In addition to the technical specification aspects offered by the DMS platform, the DMS platform may affect an operation of various technical components to automate various aspects of the technical specification which may include resource delivery. For instance, a technical specification may be comprised of various machine/software elements necessary for the successful deployment of the technical specification. The RDMs may embody the necessary computer-readable instructions for the automated provisioning and configuration of those elements, and upon the execution of the RDM generated by the stages of the cycle, the DMS platform may transition to the provisioning stages which are also spec'd out by the RDM. Here, the RME can now act as a Rules, Mapping, and Fulfillment engine (RMFE). The Fulfillment component of the RMFE may be configured to specify, via API protocols with various external and/or third-party systems, the necessary parameters of the product/service modules necessary for the deployment of the technical specification. This include, but is not limited to, obtaining licenses, transacting money, ordering products, configuring servers, configuring software, configuring firmware, automating unit testing, and/or the deployment of any other technical provisioning and configuration requirements as defined from the analysis of the RDMs.

As the DMS embodies the entire cycle of a delivery in the same platform, from sale to maintenance, it has the necessary data to analyze for process optimization. Process optimization may comprise improved deployment planning, improved timeline/hourly requirements, improved resource allocation, and the like. Eventually, this data can be trained and develop an Al component, which can act as 1) an agent; 2) deployment manager; and 3) service representative.

Embodiments of the present disclosure may comprise methods, systems, and a computer readable medium comprising, but not limited to, at least one of the following:

A. Technical Specification Creation Module 130;

B. Technical Specification Oversight and Monitoring Module 140;

C. Technical Specification Fulfillment Module 160,
i. Technical Specification Deployment Submodule 163,
ii. Technical Specification Deployment Billing Submodule 166, and
iii. Deployment Maintenance Submodule 169;

D. Deployment Optimization Module 150,
i. Artificial Intelligence (AI) Submodule 155;

E. UI Module 110;

F. Rules Mapping Engine 170,
i. Resource Allocation Submodule 174, and
ii. Compliance and Licensing Submodule 178;

G. Memory Storage System 120.

In some embodiments, the present disclosure may provide an additional set of modules for further facilitating the software and hardware platform.

H. An AI Module.

Details with regards to each module is provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each component disclosed within each module can be considered independently without the context of the other components within the same module or different modules. Each component may contain language defined in other portions of this specification. Each component disclosed for one module may be mixed with the functionality of another module. In the present disclosure, each component can be claimed on its own and/or interchangeably with other components of other modules.

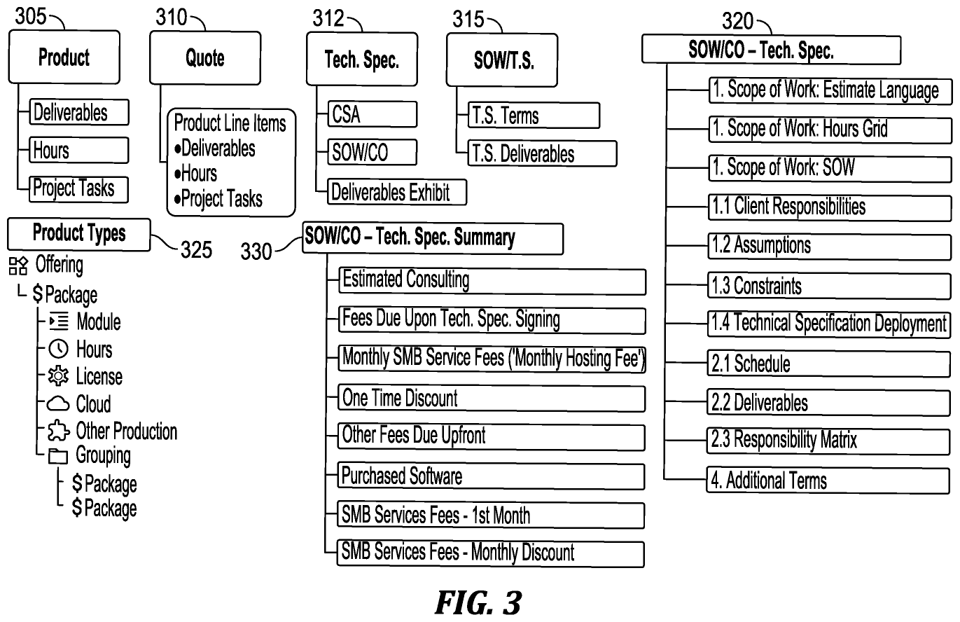

FIG. 3 illustrates a plurality of object types that may be employed by a platform consistent with embodiments of the present disclosure. It is noted that FIG. 3 only shows one example of at least a portion of technical specification and/or a technical deployment, and other examples are possible. A first object may be a product object 305. This object may define various aspects of the product to be provided by the platform such as, but not limited to, for example, the deployment deliverables, as defined by the technical specification, hourly requirements, and tasks. A product may be comprised of one or more product line items, specifying particulars associated with a product. It is further noted that FIG. 3 is nonlimiting, and that other technical implementations are possible. Another nonlimiting example of FIG. 3 may be embodied as a first object that may be a product of object 320. The object may define various aspects of the technical specification to be provided by the platform such as, but not limited to, for example, the scope of work, client responsibilities, assumptions, constraints, technical specification deployment, schedule, deliverables, responsibility matrix, and additional terms of the technical specification. A product may be comprised of one or more technical specification parameters, specifying particulars associated with a product. It should be understood that a product line item and RDM may be congruent, and used interchangeably throughout the present disclosure.

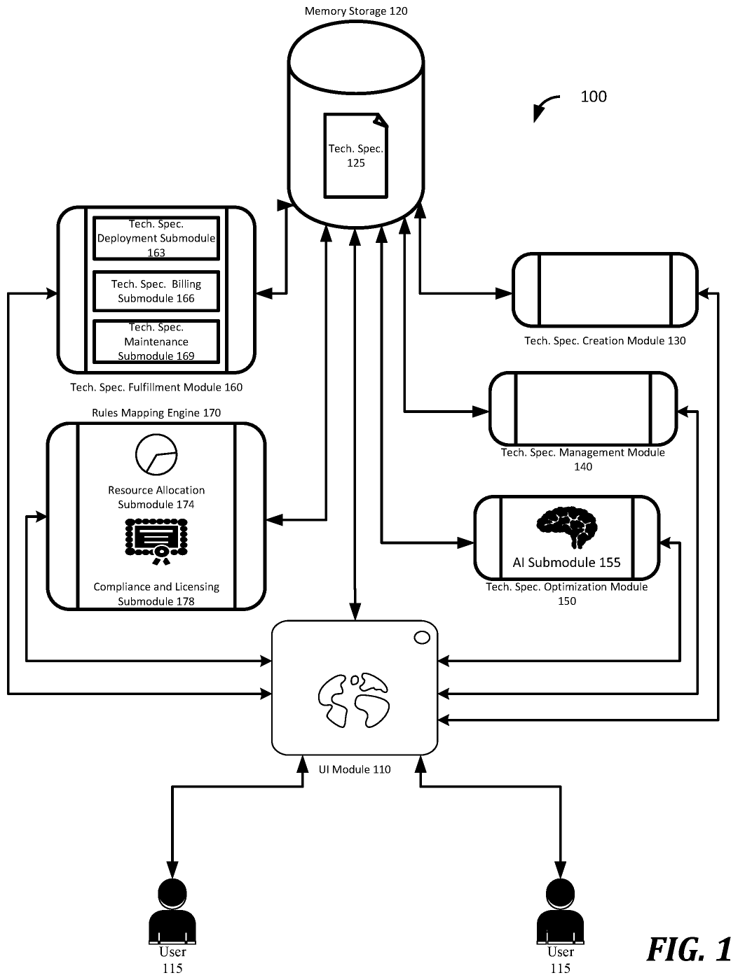

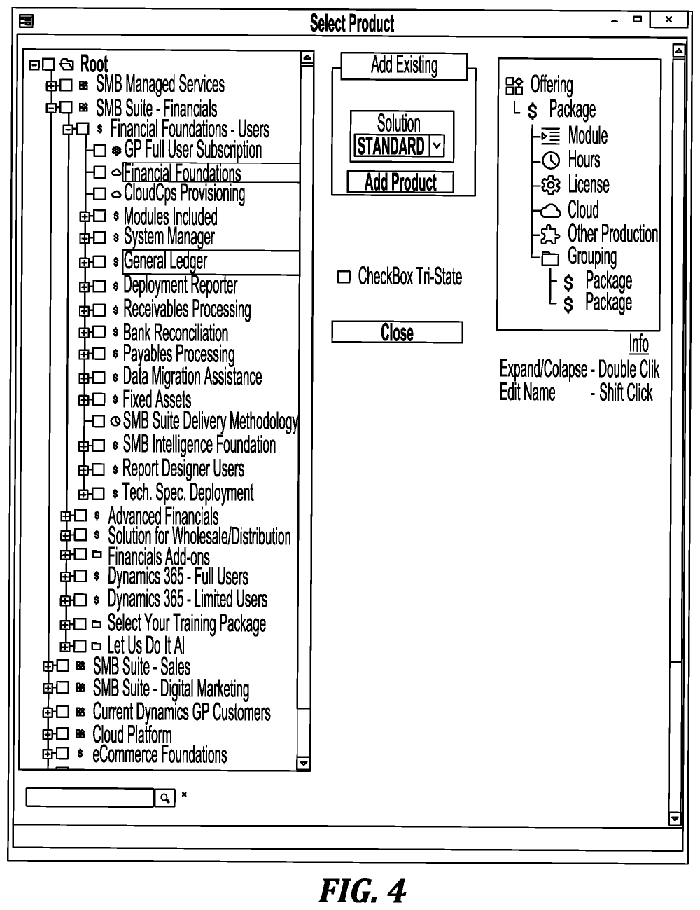

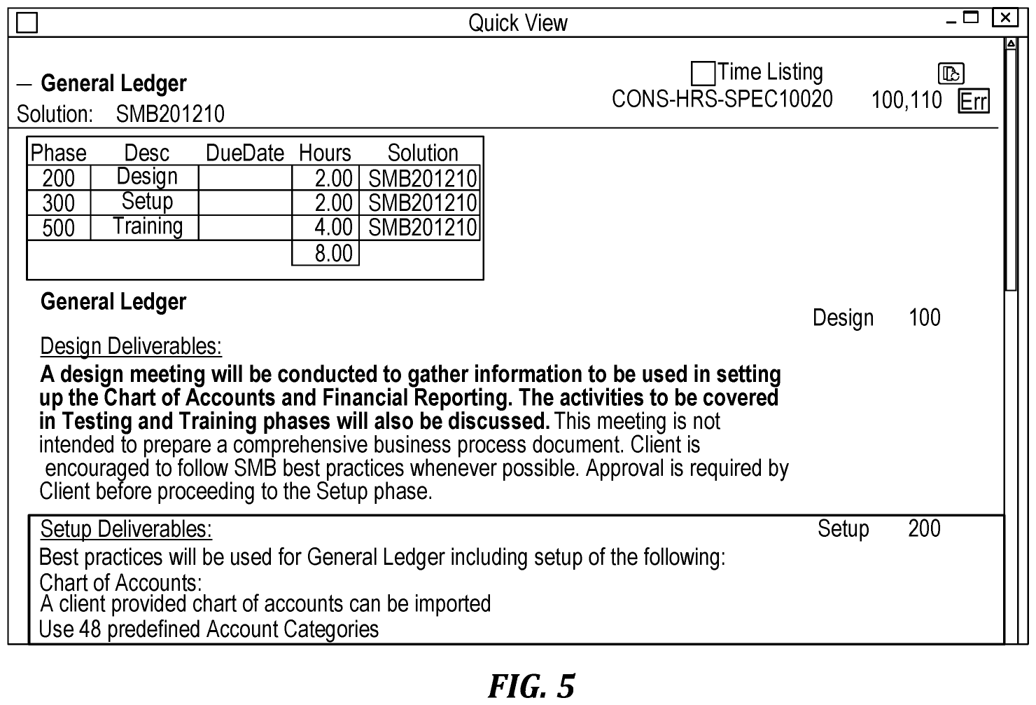

A second object may be a resource requirement projection object 310. The resource requirement projection object 310 may be configured to compile a plurality of product line items into a resource requirement projection that may be generated for a resource requirement projection phase performed by the platform. For instance, as illustrated in FIG. 4, user 115 (of FIG. 1) may be enabled to select from a plurality of products to generate a technical specification. It is noted that FIG. 4 only shows one example of at least a portion of the technical specification and/or the technical deployment, and other examples are possible. Products may be categorized as, for example, product types 325. The technical specification may be comprised of a plurality of offerings, packages, modules, and various other illustrated types and sub-types, each with corresponding parameters as defined in the product object 305. The user may be further configured to add or remove products. It is further noted that FIG. 4 is nonlimiting, and that other technical implementations are possible. Another nonlimiting example of FIG. 4 may be embodied as, for example, an interface for which the user to modify the technical specification. The technical specification maybe comprised of a plurality of offerings, packages, modules, and various other illustrated types and subtypes. FIG. 5 illustrates a user interface that is operative to provide additional details of a product upon selection. It is noted that FIG. 5 only shows one example of a technical specification and/or technical deployment, and other examples are possible. An Application Programming Interface (API) shows the implementation of a general ledger. This shows the aspects of the General Ledger design, setup, and training among other elements. It is further noted that FIG. 5 is nonlimiting, and that other technical implementations are possible. Another nonlimiting example of FIG. 5 may be embodied as, for example, a general ledger. In some embodiments this may show the aspects of the resources associated with the technical specification and/or technical deployment.

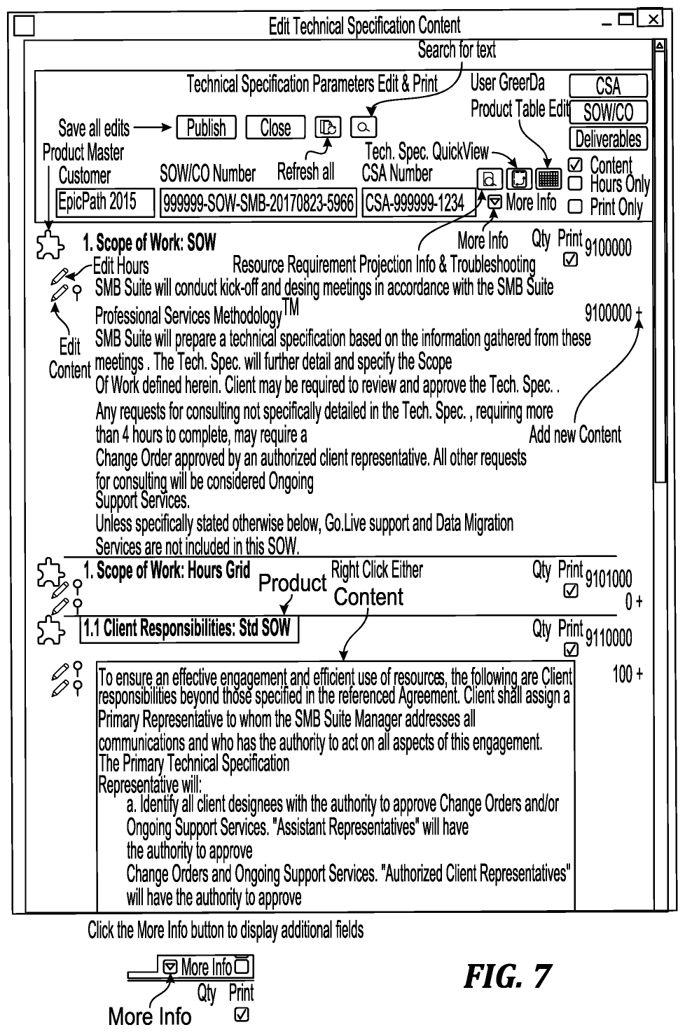

Having selected a plurality of products and related items associated therewith, user 115 may generate a resource requirement projection. The resource requirement projection may compile a plurality of product lines to generate opportunities. The opportunities may refer to potential technical specifications that may be engaged by the platform. In some embodiments, the potential technical specifications may be embodied in, for example, a third object, a technical specification selection 312. The product lines may provide details used by the platform to generate a resource requirement projection, which together may be used to generate the technical specification. The technical specification may be populated by, for example, the CSA, statement of work (SOW), and additional deliverables exhibit. Technical specification automation may communicate the technical specification to interested parties for review, approval, and execution. The SOW 315, Technical Specification Terms 320, and Technical Specification Summary 330 may all be extrapolated from the product object 305 as it relates to the selected product types when generating the technical specification. FIG. 7 illustrates one embodiment of a generated technical specification. At various phases, user 115 may be enabled to make modifications. It is noted that FIG. 7 only shows one example of at least a portion of the technical specification and/or the technical deployment, and other examples are possible. In some embodiments, a client change order may be generated in view of a plurality of the modifications. It is further noted that FIG. 7 is nonlimiting, and that other technical implementations are possible. Another nonlimiting example of FIG. 7 may be embodied as, for example, a means to edit technical specification parameters. In some embodiments, the client may be able to change the parameters of the technical specification and/or technical deployment.

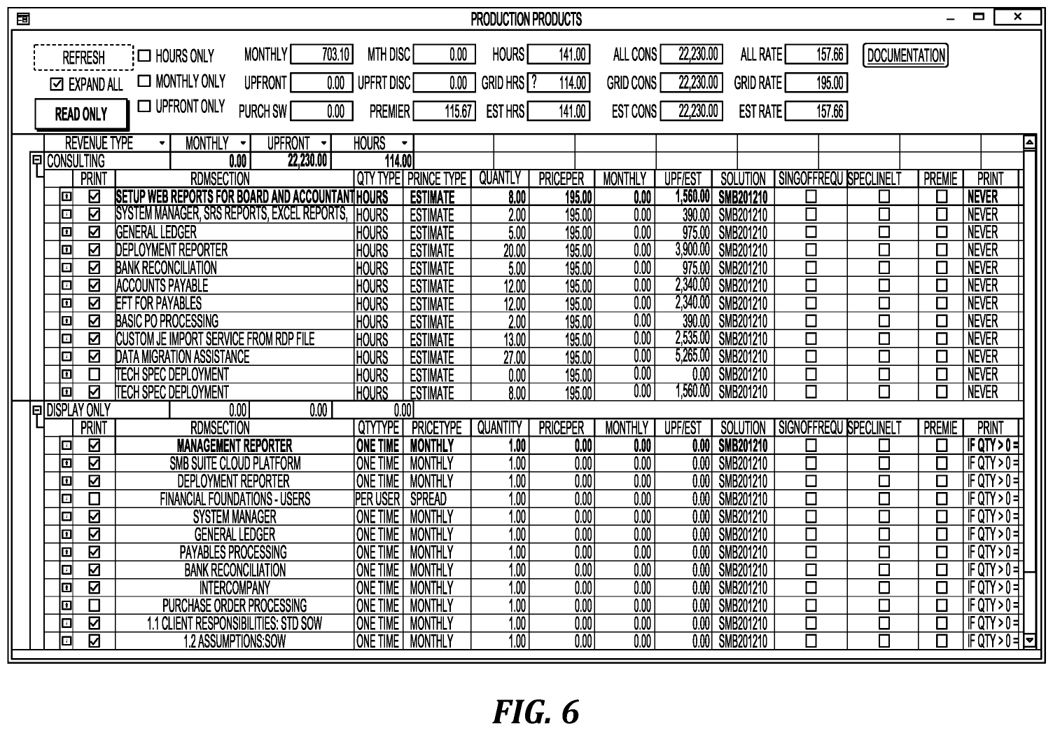

Consistent with embodiments of the present disclosure, a catalog, as illustrated by way of non-limiting example in FIG. 6, may provide a plurality of product line items, metadata associated with the product line items, and templated groupings thereof. It is noted that FIG. 6 only shows one example of at least a portion of the technical specification and/or the technical deployment, and other examples are possible. The user 115 may group together a plurality of RDMs and set terms. It is further noted that FIG. 6 is nonlimiting, and that other technical implementations are possible. Another nonlimiting example of FIG. 6 may be embodied as, for example, a means to view aspects about product lines comprising a technical specification and/or technical deployment.

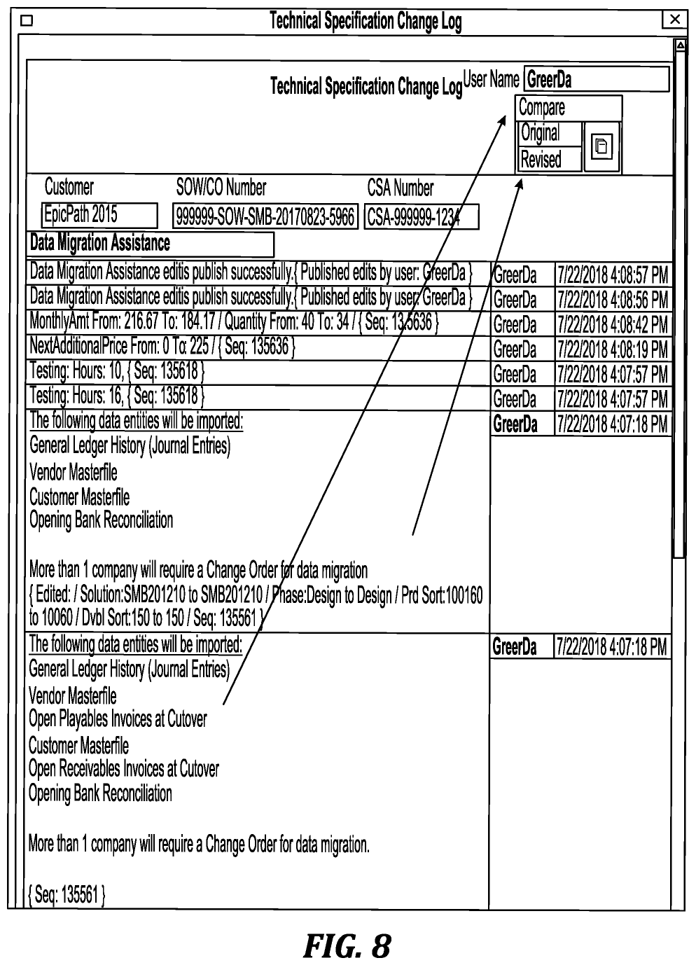

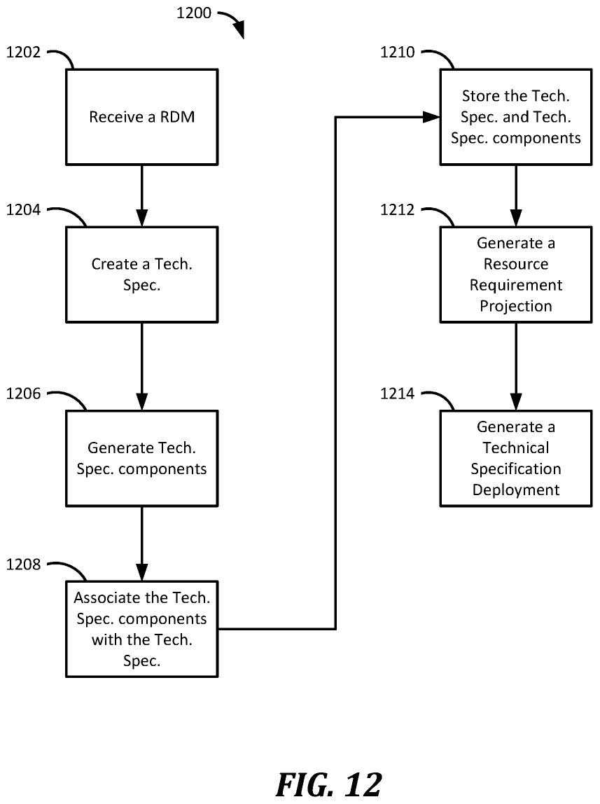

User 115 may be enabled to make modifications to each of those items for customization purposes. Those updates may be presented and available at various stages disclosed herein. FIG. 8 illustrates a change log that may reflect one or more changes made to otherwise pre-defined aspects of the products, resource requirement projections, and RDMs. It is noted that FIG. 8 only shows one example of at least a portion of the technical specification and/or the technical deployment, and other examples are possible. It is further noted that FIG. 8 is nonlimiting, and that other technical implementations are possible. Another nonlimiting example of FIG. 8 may be embodied as, for example, an interface that may enable the user to inspect how aspects of a technical specification and/or deployment have been utilized by the system. As part of the process, user 115 may be enabled to define financial terms associated with the deployment of the technical specification (e.g., payment terms), as illustrated in FIG. 12. It is noted that FIG. 12 only shows one example of at least a portion of the technical specification and/or the technical deployment, and other examples are possible.

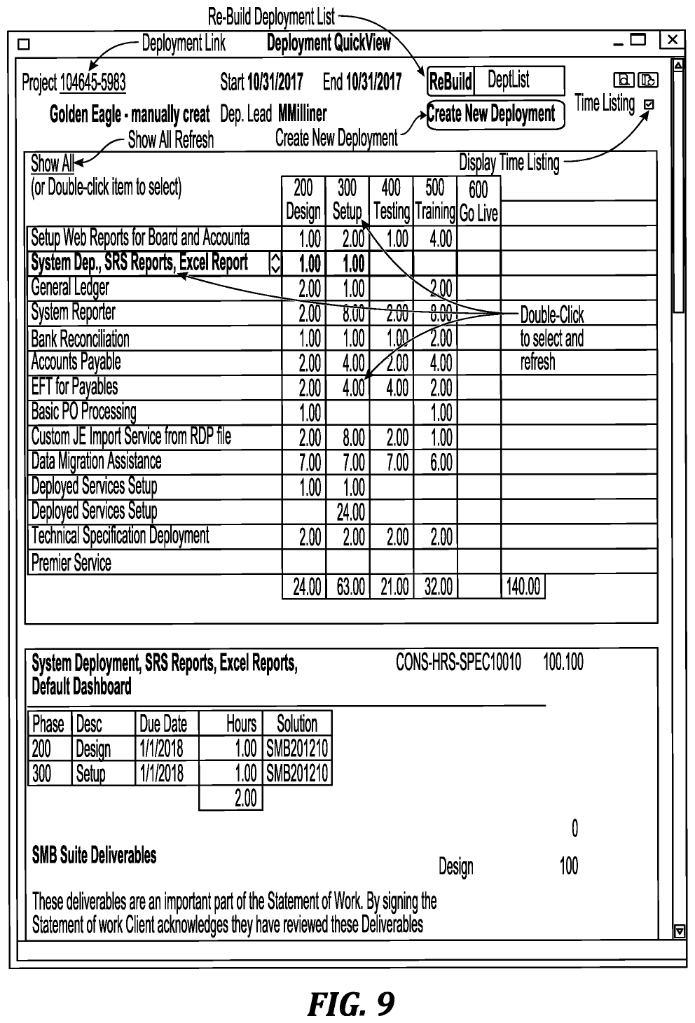

In various embodiments, the User Interface (UI) may present a potential deployment system. A deployment system may be presented as illustrated, by way of non-limited example, in FIG. 9. It is noted that FIG. 9 only shows one example of at least a portion of the technical specification and/or the technical deployment, and other examples are possible. It is further noted that FIG. 9 is nonlimiting, and that other technical implementations are possible. Another nonlimiting example of FIG. 9 may be embodied as, for example, an interface that may enable the user to inspect a report that may outline the deployment status of a technical specification and/or technical deployment. The deployment system plan may be segmented into a plurality of phases, as illustrated in FIG. 1. It is noted that FIG. 1 only shows one example of at least a portion of the technical specification and/or the technical deployment, and other examples are possible. The system may be derived from the plurality of selected products and corresponding to the RDMs associated with the technical specification. It is further noted that FIG. 1 is nonlimiting, and that other technical implementations are possible. Another nonlimiting example of FIG. 1 may be embodied as a system that may be derived from user interaction with UI module 110 corresponding with the plurality of selected products. The deployment overview may display the various phases, the technical resources involved, the hours committed, deadlines, and various other aspects of the deployment. The plan may show the on-going deployment and can show the user the line items associated with the deployment of the technical specification. The user may also define deliverables associated with the tasks during the deployment.

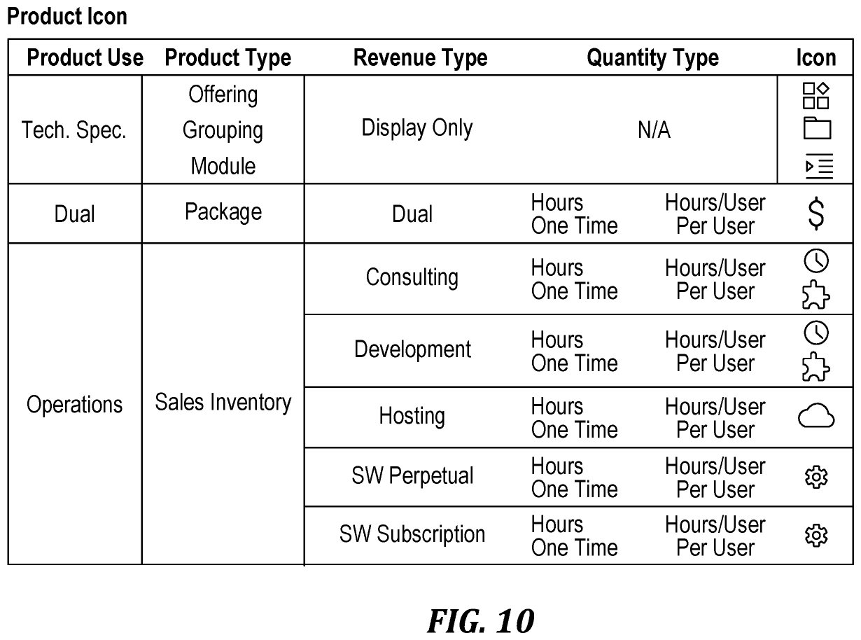

FIG. 10 illustrates an embodiment of specifying various aspects of the technical specification. The technical specification may be executed by automated means, as will be discussed with reference to FIG. 1 and the various modules associated therewith. It is noted that FIG. 10 only shows one example of at least a portion of the technical specification and/or the technical deployment, and other examples are possible In this view the user 115 may define the templates and product types. Each product has a product type. The product type determines the different attributes associated with the product such as, for example a cloud product and/or a licensing product. Technical specification products are outward facing. Operations products are the products that client often does not see. Packages may have both technical specification and operations products outwardly and internally facing. It is further noted that FIG. 10 is nonlimiting, and that other technical implementations are possible. Another nonlimiting example of FIG. 10 may be embodied as, for example, a means for the user to interface with products associated with the technical specification and/or technical deployment. The user may, for example, inspect the interface to determine which outside products are associated with the technical specification.

The functions executed by be defined by the technical specification, the products associated therewith, and related product lines. Furthermore, assignment, deployment, and review/approval functionality may be automated at various stages of the technical specification. Further still, billing and collections procedures may be automated at various stages of the technical specification. Billing and collections procedures may be defined by the resource requirement projection terms specified at the time of technical specification creation and execution.

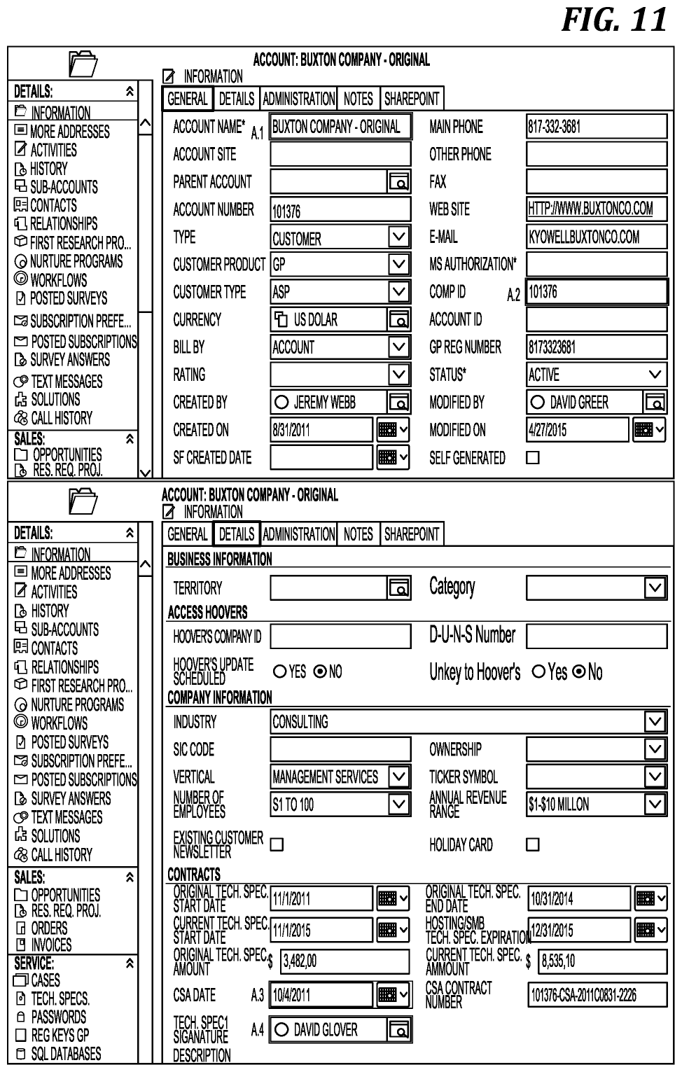

Still consistent with embodiments of the present disclosure, a deployment system may be tied to an account. Each account may be associated with one or more deployment systems. FIG. 11 illustrates one embodiment of a user interface displaying accounts and related deployment systems information. The related information can provide technical specification details, phases of execution, assignments, hours, deployments, and billing. It is noted that FIG. 11 only shows one example of at least a portion of the technical specification and/or the technical deployment, and other examples are possible. It is further noted that FIG. 11 is nonlimiting, and that other technical implementations are possible. Another nonlimiting example of FIG. 11 may be embodied as, for example, a means for a user interface to interface with a user's account details relating to products associated with the technical specification and/or technical deployment of the user.

In some embodiments, a Customer UI may be provided. The customer UI may enable transparency into the technical specification execution process. Furthermore, the customer UI may enable a customer to review and approve various aspects of the technical , serving as a gatekeeper from further technical specification execution. Similarly, the customer UI may enable the payment of the resource requirement projection, by which the platform may be configured to impede execution of the technical specification until paid.

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 1300 may be employed in the performance of some or all of the stages disclosed with regard to the methods. Similarly, an apparatus may be employed in the performance of some or all of the stages of the methods. As such, the apparatus may comprise at least those architectural components as found in computing device 1300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

FIG. 12 illustrates a block diagram of an example method 1200 for operating the computer device 1300 (of FIG. 3) is described below:

In block 1202, the device is operative to receive at least one RDM from at least one of the following:

a. At least one selection made by a user,

b. At least one selection made by an admin,

c. The at least one RDM associated with a data element from the at least one data element selected by the user, and

d. The at least one RDM associated with the data element from the at least one data element selected by the admin,

Retrieve the at least one rule from the memory storage,

Generate a technical specification, wherein generating the technical specification comprises the following:

Creating a blank technical specification in block 1204,

Generating technical specification components in block 1206, wherein the generating of technical specification components comprises the following:

a. Generate at least one hour requirement, using the received at least one RDM and the retrieved at least one rule,

b. Generate at least one additional RDM, using the received at least one RDM and the retrieved at least one rule,

c. Retrieve at least one additional rule, using the received at least one RDM and the retrieved at least one rule,
1. Wherein, the at least one additional rule may be retrieved to meet a compliance requirement,

d. Generate at least one stage, using the received at least one RDM and the retrieved at least one rule,

e. Generate at least one human resource assignment, using the received at least one RDM and the retrieved at least one rule,

f. Generate at least one activity, wherein the generating of at least one activity comprises calculating at least one activity parameter using the following values:
1. at least one RDM,
2. at least one time requirement,
3. a temporal parameter,
4. a cost estimation,
5. a machine activity,
6. a software activity, and
7. an administrative activity, and
8. at least one rule,

g. Retrieve at least one module, wherein the retrieving at least one module comprises the following:

h. Identifying at least one module for retrieval based on the received at least one RDM and the retrieved at least one rule,

i. Retrieving the identified at least one module,

j. Identify at least one resource based on the received at least one RDM,

k. Wherein a resource may comprise at least one of the following:
1. Software,
2. Hardware,
3. License,
4. Product,
5. Real estate,
6. Commodity,
7. Currency, such as fiat currency and digital currency,

Associating the technical specification components with the technical specification in block 1208, and

Store the technical specification and the technical specification components in the memory storage in block 1210,

Generate a resource requirement projection in block 1212, using the generated deployment system,

a. Wherein generating a resource requirement projection comprises the following:
1. Customizing of zero or more RDMs,
2. Customizing of zero or more costs, and
3. Providing the resource requirement projection to the user,

Generate a technical specification in block 1214, using the received at least one RDM and the retrieved at least one rule,

a. Wherein generating a deployment system, generating the technical specification, and generating the resource requirement projection, using the received at least one RDM and the retrieved at least one rule, comprises processing the at least one rule and at least one RDM by applying every rule within the at least one rule to each RDM.

Although the aforementioned method has been described to be performed by the platform 100, it should be understood that computing device 1300 may be used to perform the various stages of the method. Furthermore, in some embodiments, different operations may be performed by different networked elements in operative communication with computing device 1300. For example, a plurality of computing devices may be employed in the performance of some or all of the stages in the aforementioned method. Moreover, a plurality of computing devices may be configured much like a single computing device 1300. Similarly, an apparatus may be employed in the performance of some or all stages in the method. The apparatus may also be configured much like computing device 1300.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, at least one computing device 1300 may be employed in the performance of some or all of the stages disclosed with regard to the methods. Similarly, an apparatus may be employed in the performance of some or all of the stages of the methods. As such, the apparatus may comprise at least those architectural components as found in computing device 1300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

A. Technical Specification Deployment Method

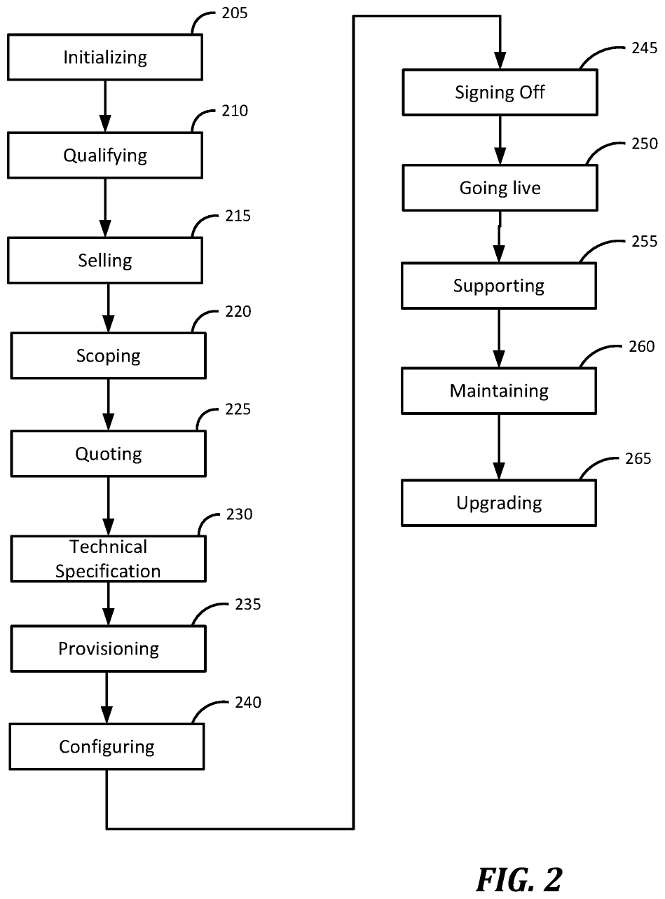

FIG. 2 illustrates a block diagram of a method of operation. It is noted that FIG. 2 only shows one example of at least a portion of the technical specification and/or the technical deployment, and other examples are possible
1. Initializing 205, wherein the initializing may comprise at least one of the following:
   1.1. Performing at least one of the following for data collection:
      1.1.1. Driving traffic volume to a website, and
      1.1.2. Capturing data about at least one prospect selected from the visitors to the website, wherein the capturing data may comprise, but not limited to, at least one of the following:
         1.1.2.1. Capturing identifiers for the at least one prospect such as, but not limited to, IP address and cookie unique identifier, and
         1.1.2.2. Capturing how the at least one prospect found the website,
   1.2. Presenting for selection, by the at least one prospect, relevant modules and/or packages for offerings and packages,
   1.3. Presenting for selection, by the at least one prospect, required modules and/or packages that may be included at a later time for upselling,
   1.4. Capturing at least some activity performed by the at least one prospect for client data, resource requirement projection and technical specification, wherein the at least some activity comprises, but not limited to, required and optional modules and/or packages selected by the at least one prospect,
   1.5. Presenting the at least one prospect with a description of the modules and/or packages selected by the at least one prospect comprising, but not limited to, at least one of the following:
      1.5.1. Best practices,
      1.5.2. High level module description, and
      1.5.3. Promotions such as, but not limited to, 80/20 promotion,
   1.6. Receiving specification of deliverables from the at least one prospect comprising, but not limited to, at least one of the following:
      1.6.1. Receiving selected standards the technical specification must adhere to,
      1.6.2. Receiving requirements for ease of technical specification management and/or convenience,
      1.6.3. Receiving safety requirements, and
      1.6.4. Receiving specification of at least one deliverable associated with at least one module from the selected modules and/or packages, and
   1.7. Receiving specification of safety control gate from the at least one prospect comprising, but not limited to at least one of the following:
      1.7.1. Receiving specification of control procedures,
      1.7.2. Receiving specification of sign off criteria, such as, but not limited to, technical specifications is only accepted after written and/or digital confirmation by a designated party, such as the at least one prospect and/or someone designated by the at least one prospect;
2. Qualifying 210, wherein the qualifying may comprise at least one of the following:
   2.1. Capturing resource requirement projection information for lifecycle data collection,
   2.2. Presenting the at least one prospect with value messaging such as, but not limited to at least one of the following:
      2.2.1. Presenting messaging designed to help the at least one prospect decide if they could afford it, and
      2.2.2. Presenting messaging designed to help the at least one prospect decide which vendor and/or platform to choose,
   2.3. Obtaining information from the at least one prospect for upselling, such as obtaining information that may help identify else what may be done at a later time that will be valuable to the at least one prospect,
   2.4. Interacting actively with the at least one prospect to establish pricing and/or model, such as SMB model, understanding for client data, resource requirement projection information and technical specification,
   2.5. Performing module optimization for at least one module from the selected modules, comprising, but not limited to at least one of the following:
      2.5.1. Performing module optimization to meet the needs of the at least one prospect, and
      2.5.2. Performing module optimization for value standardization such as, but not limited to optimization of the 80/20 promotion at a modular level,
   2.6. Presenting information to the at least one prospect about all deliverables corresponding to the technical specification, such as, but not limited to at least one of the following:
      2.6.1. Presenting information about safety,
      2.6.2. Presenting comfort information,
      2.6.3. Presenting size information, and
      2.6.4. Presenting difficulty information, and
   2.7. Introducing sign off to the at least one prospect and reminding them that they are in control;
3. System Assessment 215, wherein the system assessment may comprise at least one of the following:
   3.1. Performing data collection for the system assessment comprising, but not limited to at least one of the following:
      3.1.1. Allocating at least one module for the system analysis, and
      3.1.2. Retrieving operating parameters of the target technical infrastructure,
   3.2. Performing a resource analysis for the system assessment comprising, but not limited to at least one of the following:
      3.2.1. Leveraging the system to, for example, determine compatibility of the solution and the target technical infrastructure, and
      3.2.2. Continuously interfacing the technical infrastructure to, for example, ensure compatibility throughout the deployment of the solution
   3.3. Generating at least one knowledgebase of modules and/or packages for offerings and packages, such as, but not limited to available packages to be provisioned by the system,
   3.4. Referencing data such as, but not limited to parameters associated with the target technical infrastructure and the resource requirement projection, for compatibility purposes, such as, but not limited to initiating new updates to the technical infrastructure which may be automated in some embodiments,
   3.5. Detailing deliverables, wherein the detailing deliverables may comprise, but not limited to, at least one of the following:
      3.5.1. Identifying gaps in, for example, compatibility relating to the solution and the technical infrastructure,
      3.5.2. Promoting standardization,
      3.5.3. Providing all relevant data to the at least one prospect to, for example, ensure proper compatibility of the solution to be integrated with the target infrastructure;
4. Scoping 220, wherein the scoping may comprise at least one of the following:
   4.1. Capturing resource requirement projection information for, for example, at least one of the following:
      4.1.1. Provisioning,
      4.1.2. Configuration,
      4.1.3. Sign off,
      4.1.4. Process, and
      4.1.5. Support,
   4.2. Utilizing value messaging to introduce at least one of the following:
      4.2.1. Easy technical specifications,
      4.2.2. Process methodology,
      4.2.3. Terms, and
      4.2.4. Roles,
   4.3. Identifying future opportunities based on, for example, offerings and packages,
   4.4. Upselling, wherein the upselling may comprise, but not limited to, at least one of the following:
      4.4.1. Promoting “start small”, and
      4.4.2. Capturing specific future opportunities with, for example, timing and triggers,
      4.4.3. Generating client data, resource requirement projection and technical specifications for the scoping, comprising, but not limited to at least one of the following:
         4.4.3.1. Capturing 80/20, and
         4.4.3.2. Architecting gap solutions,
      4.4.4. Determining custom deliverables for inclusion and/or exclusion based on, for example, module definition,
      4.4.5. Specifying parameters for deliverables, wherein the specifying parameters for deliverables may comprise, but not limited to, at least one of the following:
         4.4.5.1. Specifying timing,
         4.4.5.2. Specifying resources,
         4.4.5.3. Specifying functionality for inclusion and/or exclusion,
         4.4.5.4. Documenting deliverables, such as unique deliverables, and
         4.4.5.5. Specifying other parameters, such as, but not limited to, spending no time on 80%, and
      4.4.6. Identifying quality control gates, wherein the identifying quality control gates may comprise, but not limited to at least one of the following:
         4.4.6.1. Identifying success for deliverables, such as unique and standard deliverables, and
         4.4.6.2. Identifying gates, such as unique gates, for the at least one prospect and/or technical specification;
5. Resource Requirement Projection 225, wherein the resource requirement projection may comprise at least one of the following:
   5.1. Capturing at least one of the following for planning and/or profitability reporting:
      5.1.1. Revenue,
      5.1.2. Cost, and
      5.1.3. Resource requirements,
   5.2. Utilizing value messaging to perform at least one of the following:
      5.2.1. Standardize messaging, and
      5.2.2. Reinforce “start small, it's available later”,
   5.3. Providing the at least one prospect with a live and interactive resource requirement projection comprising, but not limited to, at least one of the following:
      5.3.1. Summarization,
      5.3.2. Details about modules and/or deliverables, wherein the details may comprise, but not limited to, the following:
         5.3.2.1. Drill down details,
         5.3.2.2. Details that are tied to messaging, such as website messaging, and
         5.3.2.3. Details that are tied to deliverables,
      5.3.3. Promoting self service for the at least one prospect,
      5.3.4. Validating technical specification and product prerequisites,
      5.3.5. Performing at least one of the following on the deliverables:
         5.3.5.1. Immortalizing,
         5.3.5.2. Promoting safety and/or value, and
         5.3.5.3. Tracking changes to standard associated with each deliverable, and
      5.3.6. Performing at least one of the following quality control actions:
         5.3.6.1. Communicating size and nature of the resource requirement projection, and
         5.3.6.2. Capturing data, wherein data may comprise data for at least one of the following:
            5.3.6.2.1. Technical specifications,
            5.3.6.2.2. Provisioning,
            5.3.6.2.3. Deployment, such as technical specification deployment,
            5.3.6.2.4. Sign off,
            5.3.6.2.5. Support,
            5.3.6.2.6. Maintenance,
            5.3.6.2.7. Upgrades,
            5.3.6.2.8. Billing structures,
            5.3.6.2.9. Licensing commitments, and
            5.3.6.2.10. Financials related to the at least one prospect and/or technical specification;
6. Technical Specifications 230, wherein the technical specifications may comprise at least one of the following:
   6.1. Following same resource requirement projection format for electronic acceptance,
   6.2. Capturing commitment for the at least one prospect from, for example, a resource requirement projection,
   6.3. Providing the offerings and/or the packages for self-service purchase by the at least one prospect,
   6.4. Receiving approval and acceptance from the at least one prospect, and
   6.5. Validating at least one of the following:
      6.5.1. Resource availability,
      6.5.2. Gap solutions,
      6.5.3. Architecture,
      6.5.4. Delivery team, and
      6.5.5. Custom deliverables;
7. Converting the at least one prospect to a client;
8. Provisioning 235, wherein the provisioning may comprise at least one of the following:
   8.1. Providing a client portal status page comprising, but not limited to, at least one of the following:
      8.1.1. Provisioning configuration,
      8.1.2. Technical specification details,
      8.1.3. Resource usage information, and
      8.1.4. Self-service tools,
   8.2. Performing standard deployment steps for facilitating at least one of scalability, quality, and training,
   8.3. Providing the client with access, such as online access, to at least one of the following to, for example, promote self-service and/or reduce questions:
      8.3.1. The client portal status page,
      8.3.2. Resource requirement projection,
      8.3.3. Technical specification, and
      8.3.4. Deliverables,
   8.4. Performing at least one of the following based on the deliverables:
      8.4.1. Performing automated provisioning,
      8.4.2. Executing manual technical specification steps,
      8.4.3. Conducting research and development,
      8.4.4. Refining resource requirement standards based on, for example, captured data comprising at least one of the following:
         8.4.4.1. Hours,
         8.4.4.2. Storage,
         8.4.4.3. At least one license, and
         8.4.4.4. At least one facility,
      8.4.5. Generating financial forecasting,
      8.4.6. Managing efficiency, and
      8.4.7. Identifying automation steps, based on, for example, usage, and
   8.5. Demonstrating signoff steps to the client for, for example, easy acceptance and/or training;
9. Configuring 240, wherein the configuring may comprise at least one of the following:
   9.1. Specifying at least one activity with objectives for, for example, engaging and/or demonstrating to the client, associated with at least one of the following:
      9.1.1. Deliverables
      9.1.2. Technical specification expectations,
      9.1.3. Methodology,
      9.1.4. Self-service tools,
      9.1.5. Change management tools,
      9.1.6. Signoff tools, and
      9.1.7. Training tools,
   9.2. Performing internal scope management boot camp,
   9.3. Upselling current and/or future opportunities captured by the platform 100 with strict adherence to deliverables,
   9.4. Providing change order management tools to the client comprising, but not limited to, the following:
      9.4.1. Tools for at least one of resource requirement projection, deliverables, and self-service,
      9.4.2. Tools for leveraging existing technical specifications and/or deliverables, and
      9.4.3. Tools for leveraging existing modules and/or deliverables,
   9.5. Performing at least one of the following based on the deliverables:
      9.5.1. Technical specification planning,
      9.5.2. Reporting,
      9.5.3. Resource planning,
      9.5.4. Performing management, such as, but not limited to efficient management and change management,
      9.5.5. Billing,
      9.5.6. Compensating,
      9.5.7. Satisfying client, and
      9.5.8. Preventing scope creep, and
   9.6. Driving the client to online portal for signoff as often as possible by, for example, utilizing methodology with multiple required hard gates;
10. Signing Off 245, wherein the signing off may comprise at least one of the following:
   10.1. Providing the client with quality control data captured in at least one prior step,
   10.2. Utilizing value messaging to perform at least one of the following:
      10.2.1. Control messaging,
      10.2.2. Safety messaging, and
      10.2.3. Reinforce “This is for your” messaging,
   10.3. Upselling current and/or future opportunities captured by the platform 100 with strict adherence to deliverables,
   10.4. Performing partner quality assurance,
   10.5. Integrating sign off history with technical specification data and providing it to the client,
   10.6. Providing modules used for the upselling in the self-service tools,
   10.7. Performing the following based on the smallest unit of accountability, such as, for example, the deliverables:
      10.7.1. Receiving sign offs and compensating based on each received signoff,
   10.8. Performing at least one of the following based on the quality control gates:
      10.8.1. Facilitating change management,
      10.8.2. Stopping process on deliverables where the client refused to sign off, and
      10.8.3. Verifying success defined by the scoping;
11. Going Live 250, wherein the going live may comprise at least one of the following:
   11.1. Reinforcing self-service upselling,
   11.2. Repeating kickoff messaging from the configuration step 240,
   11.3. Pointing users to website packaging for any surprise gaps in functionality,
   11.4. Stepping the client through the use of the self-service tools, wherein stepping the client through the use of the self-service tools may comprise at least one of the following:
      11.4.1. Adding users,
      11.4.2. Removing users, and
      11.4.3. Allocating storage,
   11.5. Performing at least one of the following based on the deliverables:
      11.5.1. Providing functional requirements,
      11.5.2. Avoiding false starts, and
      11.5.3. Comparing all gaps to the deliverable,
   11.6. Facilitating to support help desk, wherein the facilitating to support help desk may comprise receiving signoff from the client to, for example, mitigate risk;
12. Supporting 255, wherein the supporting may comprise at least one of the following:
   12.1. Performing at least one of the following for lifecycle data collection:
      12.1.1. Highlighting promotions for help desk personnel, and
      12.1.2. Recording all activity,
   12.2. Utilizing value messaging to perform at least one of the following:
      12.2.1. Consistently point client to self service and/or training, and
      12.2.2. Highlighting knowledgebase,
   12.3. Pointing users to website packaging for any surprise gaps in functionality,
   12.4. Upselling, wherein the upselling may comprise, but not limited to, at least one of the following:
      12.4.1. Highlighting promotions and/or specials,
      12.4.2. Asking the client about other needs, and
      12.4.3. Compensating support staff for new business,
   12.5. Providing technical specification functionality to the support staff,
   12.6. Providing support for the deliverables when a support request is within the functional requirements for the deliverable, and
   12.7. Receiving sign off for every support request from the client, wherein the receiving sign off for every support request from the client may comprise investigating requests where the client does not provide sign off;
13. Maintaining 260, wherein the maintaining may comprise at least one of the following:
   13.1. Maintaining the technical specification based on meta data of the client and/or platform 100, wherein maintaining the technical specification may comprise at least maintenance activity based on client technical specification,
   13.2. Recoding all maintenance activities, wherein
   13.3. Reporting to the client all recorded maintenance activities,
   13.4. Tracking and forecasting the resource requirements,
   13.5. Facilitating communication and quality of at least one maintenance activity,
   13.6. Associating maintenance items with at least one test plan, and
   13.7. Receiving, from the client, sign off for each maintenance activity; and
14. Upgrading 265, wherein the upgrading may comprise at least one of the following:
   14.1. Providing framework for planning,
   14.2. Forecasting resource requirements,
   14.3. Defining upgrade parameters, wherein the defining upgrade parameters may comprise defining upgrade parameters used for at least one test plan, and
   14.4. Receiving, from the client, sign off for the upgrade parameters.

### III. Technical Specification Method

1. Performing authentication method and continuing if an authentication success message is returned.
   a. In some embodiments consistent with the present disclosure, available selections such as, but not limited to, list of available templates and list of available RDMs, may be restricted based on metadata associated with the authenticated user.
      i. In some embodiments, the restrictions may be defined by an administrator.
2. Managing data elements by, for example, performing a data element manipulation method comprising creating and/or modifying and/or deleting at least one template
   a. Wherein managing data elements may further comprise providing a user with management capabilities via, for example, the UI Module
3. (Technical specification creation module) Creating a new technical specification, wherein creating the new technical specification comprises the following:
   a. Retrieving a list of available data elements from the Memory Storage.
   b. Receiving the data element selection from the user, wherein receiving the data element selection for the user may comprise an interface for selection, provided by, for example, the UI module
      i. If template is selected, perform the following steps:
         1. Retrieving data elements associated with the at least one template from the memory storage.
         2. Adding the retrieved data elements to current RDMs.
      ii. If template is not selected, set the current RDMs to empty.
   c. Retrieving a list of available RDMs for selection from the memory storage
   d. Receiving a selection of at least one RDM selected by the user, wherein receiving the at least one RDM selected by the user may comprise an interface for selection, provided by, for example, the UI module, which may present the user with the list of available RDMs
      i. If at least one RDM is selected, the at least one RDM to current RDMs.
      ii. If at least one RDM is not selected, leave the current RDMs unchanged.
   e. Receiving an indication for creation of at least one RDM from the user, wherein receiving an indication for creation of at least one RDM from the user may comprise an interface for selection, provided by, for example, the UI module
   f. Generating a technical specification based on the current RDMs
      i. Wherein, generating the technical specification may comprise at least one of the following
         1. Generating the technical specification via, for example, Rules Mapping Engine (RME)
         2. Optimizing the generated technical specification via, for example, Deployment Optimization Module
            a. In some embodiments consistent with the present disclosure, optimizing may be performed by an AI
   g. Storing the deployment systems technical specification in the memory storage
4. Engaging via, for example an engagement method
5. Deploying the current technical specification via, for example technical specification fulfillment module, comprising the following:
   a. Provisioning resources,
   b. Generating actions,
   c. Generating at least one technical specification,
   d. Generating resource requirement projection,
   e. Notifying involved parties, and
   f. Establishing communication with at least one customer user;
6. Configuring and/or monitoring and/or Managing and/or Updating the current technical specification, wherein managing existing technical specification comprises the following:
7. Maintaining and supporting the current deployment of the technical specification via, for example, a deployment optimization method;
8. Upgrading the current deployment of the technical specification.
   a. Authentication Method
9. Retrieving a list of users and associated metadata from the memory storage, such as, but not limited to at least one of the following:
   a. password hash;
   b. Username;
   c. Whitelisted source IPs; and
   d. Blacklisted source IPs.
10. Retrieving authentication data from a user or a computing device operating on behalf of a user, wherein the authentication data may comprise a username and at least one of the following from a user or a computing device operating on behalf of a user:
   a. Password;
   b. API key;
   c. Biometrics; and
   d. At least one additional authentication parameter, such as, but not limited to 2FA.
11. Comparing the retrieved authentication data with the list of users and associated metadata.
   a. If all of the retrieved authentication data matches at least one user and associated metadata from the list of users, provide authentication success signal to the platform.
      i. Wherein the authentication success signal may comprise at least one of the following:
         1. Username;
         2. Time of authentication;
         3. Number of attempts; and
         4. Metadata associated with the authenticated user.
   b. In all other cases, provide an authentication failed signal to the platform.
      i. Wherein the authentication failed signal may comprise at least one of the following:
         1. An error message such as, but not limited to “Incorrect Password”;
         2. Username;
         3. Time of authentication;
         4. Number of attempts; and
         5. Metadata associated with the authenticated user.
      ii. In some embodiments consistent with the present disclosure, upon an authentication failed message, the authentication method may be performed again a predetermined number of times.
         1. In some embodiments, a number of attempts may be incremented with each failed authentication.
         2. In some embodiments, the predetermined number may be set by an Administrator.
   b. Data Element Manipulation Method
12. Performing authentication method, and continuing if an authentication success message is returned.
   a. In some embodiments consistent with the present disclosure, available selections such as, but not limited to, list of available data elements (by way of nonlimiting example, a list of available templates) and list of available RDMs, may be restricted based on metadata associated with the authenticated user.
      i. In some embodiments, the restrictions may be defined by an administrator.

c. Technical Specification Management Method
13. Retrieving a list of available deployment systems for selection from the Memory Storage.
14. Presenting a user with a UI for selection of a technical specification for configuration from the list of available deployment systems.
15. Receiving the technical specification selection from the user, wherein receiving the technical specification selection from the user may comprise an interface for selection, provided by, for example, the UI module
   a. If a technical specification is selected, perform the following steps:
      i. Retrieving technical specification parameters associated with the at least one technical specification from the memory storage, wherein the technical specification parameters may comprise, but not limited to the following:
         1. The at least one RDM,
         2. The at least one rule,
         3. The at least one activity,
         4. The at least one module,
         5. The at least one technical specification,
         6. The at least one resource, and
         7. The at least one data element;
      ii. Setting the selected technical specification as the current technical specification for configuration.
   b. If a technical specification is not selected, go to step 4.
16. Presenting the user with a UI for viewing and/or modifying the current technical specification and/or analytics data
   a. Wherein the presenting the user with a UI for viewing and/or modifying the current technical specification and/or analytics data may comprise at least one of the following:
      i. Repeating steps 2d-h until the user finishes modifying the current technical specification
      ii. Enabling the user to review analytics data
      iii. Enabling the user to modify the current technical specification further
         1. Wherein, modifying the current technical specification may comprise at least one of creating, deleting, and updating the at least one RDM associated with the current technical specification
         2. In some embodiments consistent with the present disclosure, the user may be enabled to directly modify at least one deployment parameter from the list of technical specification parameters.
17. Receiving user modifications.
18. Updating and generating data based on modified RDMs and/or technical specification parameters, wherein updating and generating data may comprise, but not limited to the following:
   a. Recalculating values such as, but not limited to costs, resources, time requirements, stages, resource requirement projection, and technical specifications.
      i. Wherein recalculating values comprises recalculating via, for example, the RME by processing the at least one RDM and at least one rule
   b. Updating technical specification parameters based on the recalculating values, wherein updating technical specification parameters comprises at least one of the following:
      i. Adjusting at least one technical specification parameter of the technical specification parameters, such as, but not limited to the following
         1. Updating at least one technical infrastructure associated with the technical specification
         2. Altering status of the at least one activity
         3. Changing value of the at least one cost, and
         4. Retrieving at least one resource to be associated with the current technical specification
      ii. Creating a new technical specification parameter
      iii. Retrieving a predefined technical specification parameter, such as, but not limited to software, licenses, and modules
      iv. Deleting a technical specification parameter
   c. Generating evaluation data, such as, but not limited to, charts, reports, and resource requirement projection information.
19. Updating the current technical specification with the updated technical specification parameters and/or evaluation data.
20. Saving the current technical specification and to the memory storage
   a. In some embodiments consistent with the present disclosure, after saving the technical specification, the user may continue to modify the technical specification by following the procedure from step 2d
21. Receiving an indication for deployment of the current technical specification from the user.

### IV. Platform Configuration

FIG. 1 illustrates one possible operating environment through which a platform consistent with embodiments of the present disclosure may be provided. By way of non-limiting example, a data processing platform 100 may be hosted on, for example, a cloud computing service. In some embodiments, the platform 100 may be hosted on a computing device 1300. A user may access platform 100 through a software application and/or hardware device. The software application may be embodied as, for example, but not be limited to, a website, a web application, a desktop application, and a mobile application compatible with the computing device 1300.

UI Module 110

In some embodiments consistent with the present disclosure, a UI module 110 may be provided. In some embodiments, the UI module 110 may provide at least one user 115 to, for example, perform at least one of the following:
Create at least one technical specification;
Monitor at least one technical specification;
Modify at least one technical specification;
View status of at least one technical specification;
Delete at least one technical specification;
Sign off on at least one task on at least one technical specification; and
Perform billing operations on at least one technical specification.

Memory Storage 120

In some embodiments consistent with the present disclosure, a memory storage 120 may be provided. In some embodiments, the memory storage 120 may store data associated with, for example, at least one technical specification 125, at least one data element, at least one user 115, and/or at least one RDM. The memory storage 120 may be in operative communication with the other modules disclosed here in for data storage and retrieval. RDMs may be added or removed, and grouped as data elements.

Technical Specification Creation Module 130

In some embodiments consistent with the present disclosure, a technical specification creation module 130 may be provided. In some embodiments, the technical specification creation module may facilitate establishing initial parameters for a project 125 stored in, for example, the memory storage 120. In some embodiments, the technical specification creation module 130 may receive the initial parameters for technical specification 125 creation from a user 115 via, for example, the UI module 110. In some embodiments, predefined sets of initial parameters may be grouped into data elements that are stored, for example, in the memory storage 120. A user 115 may choose a data element via, for example, UI module 110, which in turn will allow the technical specification creation module 130 to retrieve and/or generate all the necessary initial parameters for technical specification 125 creation. In some embodiments, at least one initial parameter may be generated by, for example, technical specification optimization module 150 and/or the AI submodule 155.

Technical Specification Monitoring Module 140

In some embodiments consistent with the present disclosure, a technical specification monitoring module 140 may be provided. In some embodiments, the technical specification monitoring module 140 may provide, for example, monitoring, reporting, status viewing, modification, and/or sign off capabilities throughout the technical specification 125. In some embodiments, the technical specification monitoring module 140 may be in operative communication with at least one user 115 via, for example, UI module 110.

Project Technical Specification Deployment Optimization Module 150

In some embodiments consistent with the present disclosure, a technical specification deployment module 150 may be provided. In some embodiments, the technical specification deployment module 150 may alter at least one parameter associated with a technical specification 125 in order to improve the outcome. For example, the technical specification deployment module 150 may analyze which tasks are dependent on other tasks, and which tasks may be scheduled in parallel. Based on the analysis, the technical specification deployment optimization module 150 may then schedule all tasks in such a way, in order to perform as many tasks in parallel as possible, and minimize the total time the technical specification 125 requires to complete.

AI Submodule 155

In some embodiments consistent with the present disclosure, an AI submodule 155 may be optionally provided. In some embodiments, the AI submodule 155 may automate and further optimize the actions performed by the technical specification deployment optimization module 150. In some embodiments, the AI submodule 155 may be trained by, for example, past and or present technical specifications125, behavior of at least one user 115, internal training data, and/or external training data. The AI submodule 155 manages a project by recommending RDMs. The submodule 155 assigns resources based on past performance and trends. The module 155 provides upsell opportunities and timeline predictions.

Technical Specification Fulfillment Module 160

In some embodiments consistent with the present disclosure, a technical specification fulfillment module 160 may be provided. Automation is one of the features that drives the technical specification fulfillment module 160. The technical specification fulfillment module 160 is operative to aggregate and generate licenses, deploying code, tracking billing, assigning tasks automatically using automation features.

Technical Specification Deployment Submodule 163

In some embodiments consistent with the present disclosure, a technical specification deployment submodule 163 may be provided. In some embodiments, the technical specification deployment submodule 163 may facilitate the deployment of a technical specification 125. In some embodiments, the deployment of the technical specification 125 may comprise purchasing, deployment of software, resource release,

Technical Specification Billing Submodule 166

In some embodiments consistent with the present disclosure, a technical specification billing submodule 166 may be provided that identifies and generates financial billing information corresponding to the deployment of the technical specification.

Technical Specification Maintenance Submodule 169

In some embodiments consistent with the present disclosure, a technical specification maintenance submodule 169 may be provided that is operative to update technical specifications and the software of the system.

Rules Mapping Engine 170

In some embodiments consistent with the present disclosure, a rules mapping engine 170 may be provided to identify rules that correspond to tasks and map the rules to the tasks.

Resource Allocation Submodule 174

In some embodiments consistent with the present disclosure, a resource allocation submodule 174 may be provided that identifies resources available for the technical specification and adjusts the parameters of the deployment of the technical specification based on the identified resources.

Compliance and Licensing Submodule 178

In some embodiments consistent with the present disclosure, a compliance and licensing submodule 178 may be provided to identify work items that have compliance specifications and licensing needs and address the work items.

### V. Computing Device Architecture

Platform 100 may be embodied as, for example, but not be limited to, a website, a web application, a desktop application, backend application, and a mobile application compatible with a computing device 1300. The computing device 1300 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device.

Platform 100 may be hosted on a centralized server or a cloud computing service. Although the methods have been described to be performed by a computing device 1300, it should be understood that, in some embodiments, different operations may be performed by a plurality of the computing devices 1300 in operative communication at least one network.

Embodiments of the present disclosure may comprise a system having a central processing unit (CPU) 1320, a bus 1330, a memory unit 1340, a power supply unit (PSU) 1350, and one or more Input/Output (I/O) units. The CPU 1320 coupled to the memory unit 1340 and the plurality of I/O units 1360 via the bus 1330, all of which are powered by the PSU 1350. It should be understood that, in some embodiments, each disclosed unit may actually be a plurality of such units for the purposes of redundancy, high availability, and/or performance. The combination of the presently disclosed units is configured to perform the stages any method disclosed herein.

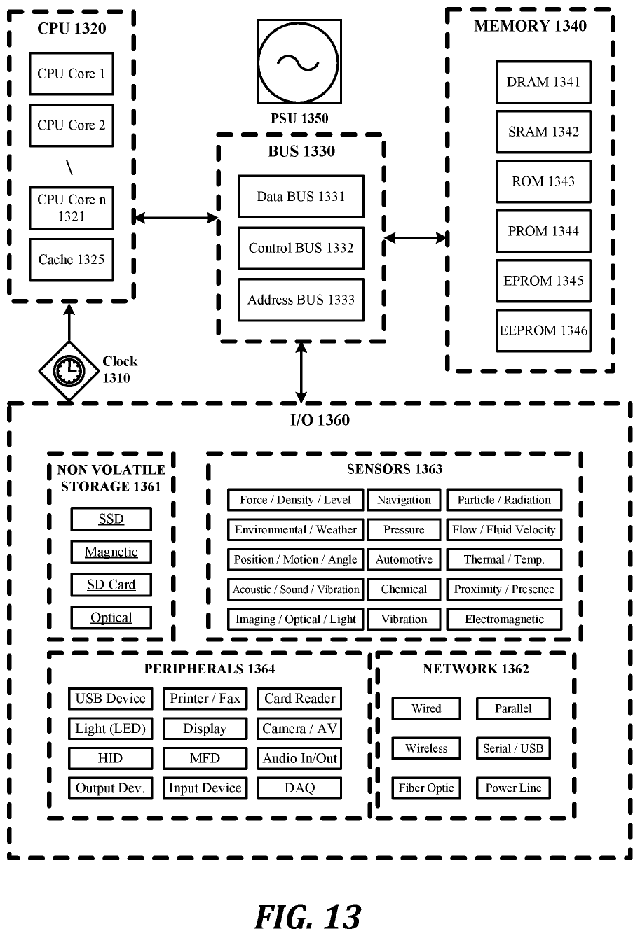

FIG. 13 is a block diagram of a system including computing device 1300. Consistent with an embodiment of the disclosure, the aforementioned CPU 1320, the bus 1330, the memory unit 1340, a PSU 1350, and the plurality of I/O units 1360 may be implemented in a computing device, such as computing device 1300 of FIG. 13. It is noted that FIG. 13 only shows one example of at least a portion of the technical specification and/or the technical deployment, and other examples are possible Any suitable combination of hardware, software, or firmware may be used to implement the aforementioned units. For example, the CPU 1320, the bus 1330, and the memory unit 1340 may be implemented with computing device 1300 or any of other computing devices 1300, in combination with computing device 1300. The aforementioned system, device, and components are examples and other systems, devices, and components may comprise the aforementioned CPU 1320, the bus 1330, the memory unit 1340, consistent with embodiments of the disclosure.

At least one computing device 1300 may be embodied as any of the computing elements illustrated in all of the attached figures. A computing device 1300 does not need to be electronic, nor even have a CPU 1320, nor bus 1330, nor memory unit 1340. The definition of the computing device 1300 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 1300, especially if the processing is purposeful.

With reference to FIG. 13, a system consistent with an embodiment of the disclosure may include a computing device, such as computing device 1300. In a basic configuration, computing device 1300 may include at least one clock module 1310, at least one CPU 1320, at least one bus 1330, and at least one memory unit 1340, at least one PSU 1350, and at least one I/O 1360 module, wherein I/O module may be comprised of, but not limited to a non-volatile storage sub-module 1361, a communication sub-module 1362, a sensors sub-module 1363, and a peripherals sub-module 1364.

A system consistent with an embodiment of the disclosure the computing device 1300 may include the clock module 1310 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 1320, the central component of modern computers, which relies on a clock. The exceptions are asynchronous circuits such as asynchronous CPUs. The clock 1310 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 1300 use a “clock multiplier” which multiplies a lower frequency external clock to the appropriate clock rate of the CPU 1320. This allows the CPU 1320 to operate at a much higher frequency than the rest of the computer, which affords performance gains in situations where the CPU 1320 does not need to wait on an external factor (like memory 1340 or input/output 1360). Some embodiments of the clock 1310 may include dynamic frequency change, where the time between clock edges can vary widely from one edge to the next and back again.

A system consistent with an embodiment of the disclosure the computing device 1300 may include the CPU unit 1320 comprising at least one CPU Core 1321. A plurality of CPU cores 1321 may comprise identical the CPU cores 1321, such as, but not limited to, homogeneous multi-core systems. It is also possible for the plurality of CPU cores 1321 to comprise different the CPU cores 1321, such as, but not limited to, heterogeneous multi-core systems, big.LITTLE systems and some AMD accelerated processing units (APU). The CPU unit 1320 reads and executes program instructions which may be used across many application domains, for example, but not limited to, general purpose computing, embedded computing, network computing, digital signal processing (DSP), and graphics processing (GPU). The CPU unit 1320 may run multiple instructions on separate CPU cores 1321 at the same time. The CPU unit 1320 may be integrated into at least one of a single integrated circuit die and multiple dies in a single chip package. The single integrated circuit die and multiple dies in a single chip package may contain a plurality of other aspects of the computing device 1300, for example, but not limited to, the clock 1310, the CPU 1320, the bus 1330, the memory 1340, and I/O 1360.

The CPU unit 1320 may contain cache 1322 such as, but not limited to, a level 1 cache, level 2 cache, level 3 cache or combination thereof. The aforementioned cache 1322 may or may not be shared amongst a plurality of CPU cores 1321. The cache 1322 sharing comprises at least one of message passing and inter-core communication methods may be used for the at least one CPU Core 1321 to communicate with the cache 1322. The inter-core communication methods may comprise, but not limited to, bus, ring, two-dimensional mesh, and crossbar. The aforementioned CPU unit 1320 may employ symmetric multiprocessing (SMP) design.

The plurality of the aforementioned CPU cores 1321 may comprise soft microprocessor cores on a single field programmable gate array (FPGA), such as semiconductor intellectual property cores (IP Core). The plurality of CPU cores 1321 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 1321, for example, but not limited to Instruction-level parallelism (ILP) such as, but not limited to, superscalar pipelining, and Thread-level parallelism (TLP).

Consistent with the embodiments of the present disclosure, the aforementioned computing device 1300 may employ a communication system that transfers data between components inside the aforementioned computing device 1300, and/or the plurality of computing devices 1300. The aforementioned communication system will be known to a person having ordinary skill in the art as a bus 1330. The bus 1330 may embody internal and/or external plurality of hardware and software components, for example, but not limited to a wire, optical fiber, communication protocols, and any physical arrangement that provides the same logical function as a parallel electrical bus. The bus 1330 may comprise at least one of, but not limited to a parallel bus, wherein the parallel bus carry data words in parallel on multiple wires, and a serial bus, wherein the serial bus carry data in bit-serial form. The bus 1330 may embody a plurality of topologies, for example, but not limited to, a multidrop/electrical parallel topology, a daisy chain topology, and a connected by switched hubs, such as USB bus. The bus 1330 may comprise a plurality of embodiments, for example, but not limited to:
Internal data bus (data bus) 1331/Memory bus
Control bus 1332
Address bus 1333
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 294 Interface/Firewire, Thunderbolt, and eXtensible Host Controller Interface (xHCI).

Consistent with the embodiments of the present disclosure, the aforementioned computing device 1300 may employ hardware integrated circuits that store information for immediate use in the computing device 1300, know to the person having ordinary skill in the art as primary storage or memory 1340. The memory 1340 operates at high speed, distinguishing it from the non-volatile storage sub-module 1361, which may be referred to as secondary or tertiary storage, which provides slow-to-access information but offers higher capacities at lower cost. The contents contained in memory 1340, may be transferred to secondary storage via techniques such as, but not limited to, virtual memory and swap. The memory 1340 may be associated with addressable semiconductor memory, such as integrated circuits consisting of silicon-based transistors, used for example as primary storage but also other purposes in the computing device 1300. The memory 1340 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 1341, Static Random-Access Memory (SRAM) 1342, CPU Cache memory 1325, Advanced Random-Access Memory (A-RAM), and other types of primary storage such as Random-Access Memory (RAM).
Non-volatile memory which can retain stored information even after power is removed, for example, but not limited to, Read-Only Memory (ROM) 1343, Programmable ROM (PROM) 1344, Erasable PROM (EPROM) 1345, Electrically Erasable PROM (EEPROM) 1346 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 1300 may employ the communication system between an information processing system, such as the computing device 1300, and the outside world, for example, but not limited to, human, environment, and another computing device 1300. The aforementioned communication system will be known to a person having ordinary skill in the art as I/O 1360. The I/O module 1360 regulates a plurality of inputs and outputs with regard to the computing device 1300, wherein the inputs are a plurality of signals and data received by the computing device 1300, and the outputs are the plurality of signals and data sent from the computing device 1300. The I/O module 1360 interfaces a plurality of hardware, such as, but not limited to, non-volatile storage 1361, communication devices 1362, sensors 1363, and peripherals 1364. The plurality of hardware is used by the at least one of, but not limited to, human, environment, and another computing device 1300 to communicate with the present computing device 1300. The I/O module 1360 may comprise a plurality of forms, for example, but not limited to channel I/O, port mapped I/O, asynchronous I/O, and Direct Memory Access (DMA).

Consistent with the embodiments of the present disclosure, the aforementioned computing device 1300 may employ the non-volatile storage sub-module 1361, which may be referred to by a person having ordinary skill in the art as one of secondary storage, external memory, tertiary storage, off-line storage, and auxiliary storage. The non-volatile storage sub-module 1361 may not be accessed directly by the CPU 1320 without using intermediate area in the memory 1340. The non-volatile storage sub-module 1361 does not lose data when power is removed and may be two orders of magnitude less costly than storage used in memory module, at the expense of speed and latency. The non-volatile storage sub-module 1361 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (1361) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD−R/DVD+R/DVD−RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO)
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor
Magnetic storage such as, but not limited to, Hard Disk Drive (HDD), tape drive, carousel memory, and Card Random-Access Memory (CRAM)
Phase-change memory
Holographic data storage such as Holographic Versatile Disk (HVD)
Molecular Memory
Deoxyribonucleic Acid (DNA) digital data storage

Consistent with the embodiments of the present disclosure, the aforementioned computing device 1300 may employ the communication sub-module 1362 as a subset of the I/O 1360, which may be referred to by a person having ordinary skill in the art as at least one of, but not limited to, computer network, data network, and network. The network allows computing devices 1300 to exchange data using connections, which may be known to a person having ordinary skill in the art as data links, between network nodes. The nodes comprise network computer devices 1300 that originate, route, and terminate data. The nodes are identified by network addresses and can include a plurality of hosts consistent with the embodiments of a computing device 1300. The aforementioned embodiments include, but not limited to personal computers, phones, servers, drones, and networking devices such as, but not limited to, hubs, switches, routers, modems, and firewalls.

Two nodes can be said are networked together, when one computing device 1300 is able to exchange information with the other computing device 1300, whether or not they have a direct connection with each other. The communication sub-module 1362 supports a plurality of applications and services, such as, but not limited to World Wide Web (WWW), digital video and audio, shared use of application and storage computing devices 1300, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 1362 may comprise a plurality of size, topology, traffic control mechanism and organizational intent. The communication sub-module 1362 may comprise a plurality of embodiments, such as, but not limited to
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 1300 may employ the sensors sub-module 1363 as a subset of the I/O 1360. The sensors sub-module 1363 comprises at least one of the devices, modules, and subsystems whose purpose is to detect events or changes in its environment and send the information to the computing device 1300. Sensors are sensitive to the measured property, are not sensitive to any property not measured, but may be encountered in its application, and do not significantly influence the measured property. The sensors sub-module 1363 may comprise a plurality of digital devices and analog devices, wherein if an analog device is used, an Analog to Digital (A-to-D) converter must be employed to interface the said device with the computing device 1300. The sensors may be subject to a plurality of deviations that limit sensor accuracy. The sensors sub-module 1363 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 1300 may employ the peripherals sub-module 1362 as a subset of the I/O 1360. The peripheral sub-module 1364 comprises ancillary devices uses to put information into and get information out of the computing device 1300. There are 3 categories of devices comprising the peripheral sub-module 1364, which exist based on their relationship with the computing device 1300, input devices, output devices, and input/output devices. Input devices send at least one of data and instructions to the computing device 1300. Input devices can be categorized based on, but not limited to:
Modality of input, such as, but not limited to, mechanical motion, audio, visual, and tactile
Whether the input is discrete, such as but not limited to, pressing a key, or continuous such as, but not limited to position of a mouse
The number of degrees of freedom involved, such as, but not limited to, two-dimensional mice vs three-dimensional mice used for Computer-Aided Design (CAD) applications

Output devices may provide output from the computing device 1300. Output devices may convert electronically generated information into a form that can be presented to humans. Input/output devices may perform both input and output functions. It should be understood by a person having ordinary skill in the art that the ensuing are non-limiting embodiments of the aforementioned peripheral sub-module 1364:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 1300. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 1300 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrument Digital Interface (MIDI) devices such as, but not limited to a keyboard, and headset.
   Data Acquisition (DAQ) devices covert at least one of analog signals and physical parameters to digital values for processing by the computing device 1300. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking device (e.g., devices disclosed in network 1362 sub-module), data storage device (non-volatile storage 1361), facsimile (FAX), and graphics/sound cards.

All rights including copyrights in the code included herein are vested in and the property of the Applicant. The Applicant retains and reserves all rights in the code included herein, and grants permission to reproduce the material in connection with reproduction of the granted patent and for no other purpose.

### VI. Aspects

The following disclose various Aspects of the present disclosure. The various Aspects are not to be construed as patent claims unless the language of the Aspect appears as a patent claim. The Aspects describe various non-limiting embodiments of the present disclosure.

Embodiments of the present disclosure may be employed on or more, or none, of the aforementioned modules, to deliver a plurality of aspects of the present disclosure. The aspects may include, but are not limited to:
1. [1] RDMs may be comprised of:
   1. Deliverable
      1. (Customer Facing)
      2. Layman's terms
      3. Used during “Sign Off”
      4. Used during creation of the technical specification
   2. Technical Specification Steps
      1. Use for Resource Management
      2. Used for Formulation/Spec'ing, Mapping, Tracking
      3. Use for Provisioning and Configuration
1. Hours Requirements
   1. Used for Resource Management
   2. Used for Deployment Formulation/Generating specification, Mapping, Tracking
   3. Used for Provisioning and Configuration
   4. Used for Billing (Note: The RDM itself is used for billing. It could be licensing, Hourly Fees or Other e.g., Hosting)
1. [2] Aggregation of RDMs
   1. RDM Parameters
   2. Grouping of RDMs
   3. Predefined RDMs
2. Processing by the Rules and Mapping Engine
   1. Verify RDM Combination (examples:)
      1. What RDMs Can Be Together?
      2. What Other RDMs are Required?
      3. What Compliance Rules Must be Met?
      4. Establish Project Stages
   2. Establish Technical Specification Deployment Activities
   3. Establish Technical Specification Deployment Costs
   4. Establish Technical Specification Deployment Requirements
   5. Establish Technical Specification Parameters (examples:)
      1. What Licenses are Required?
   6. Establish Human Resource Allocation and Assignment
   7. Establish Infrastructure Resource Allocation and Assignment
1. [3] Generate Resource Requirement Projection information
   1. Enables Customization of RDMs
   2. Definition of Technical Specification Deployment Terms
   3. Payment/Fee Types
2. Generate Technical Specification
   1. Compiled from Plurality of Sources
      1. Also based on Licenses Requirements
      2. Can import terms of third-party licenses
3. Accounting:
   1. Oversee/Manage Billing and Transactions related
   2. Facilitate communications re Upgrades
   3. Automate Renewals
4. Communications:
   1. Generate Reports/Communications with Customers
   2. Integrate with End-Customer UI for input of data

The following disclose various Aspects of the present disclosure. The various Aspects are not to be construed as patent claims unless the language of the Aspect appears as a patent claim. The Aspects describe various non-limiting embodiments of the present disclosure.

Embodiments of the present disclosure may be employed on or more, or none, of the aforementioned modules, to deliver a plurality of aspects of the present disclosure. The aspects may include, but are not limited to:
1. A platform configured for process optimization of business operational lifecycle, the platform comprising:
   A memory storage, wherein the memory storage is configured to save and retrieve the following:
      At least one resource,
         At least one RDM,
         wherein each resource within at least one resource is associated with at least one RDM from the at least one RDM,
         wherein each resource within at least one resource is associated with at least one RDM,
      At least one time requirement,
         wherein each time requirement within at least one time requirement is associated with at least one RDM from the at least one RDM,
      At least one resource assignment,
         wherein each human resource assignment, within at least one human resource assignment, is associated with at least one RDM from the at least one RDM,
      At least one rule,
         At least one activity,
         Wherein each activity comprises one of at least one deliverable and at least one technical specification,
         Wherein each activity comprises at least one activity parameter,
            Wherein each activity parameter in the at least one activity parameter comprises one of the following:
            time requirement,
            human resource assignment,
         At least one module,
         wherein each module within at least one module is associated with at least one RDM from the at least one RDM and at least one rule from the at least one rule,
      At least one physical resource,
         wherein each physical resource within at least one physical resource is associated with at least one RDM from the at least one RDM,
         Wherein the at least one physical resource may comprise at least one of the following:
            Software,
            Hardware,
            License,
            Product,
            Commodity,
            Currency, such as fiat currency and digital currency,
            Other entities that are manifested in a physical manner,
         At least one stage,
         wherein each stage within at least one stage is associated with at least one RDM from the at least one RDM and at least one rule from the at least one rule,
         At least one technical specification,
         wherein each technical specification within at least one technical specification is associated with at least one RDM from the at least one RDM,
         wherein each technical specification within at least one technical specification is associated with at least one stage,
         wherein each technical specification within at least one technical specification is associated with at least one cost,
         wherein each technical specification within at least one technical specification is associated with at least one module,
         wherein each technical specification within at least one technical specification is associated with at least one activity, and
         wherein each technical specification within at least one technical specification is associated with at least one technical specification from the at least one RDM,
         At least one resource,
         wherein each resource within at least one resource is associated with at least one RDM from the at least one RDM,
         At least one data element,
         wherein each data element within at least one data element comprises metadata associated with at least one of the following:
            The at least one RDM,
         The at least one data element,
         The at least one rule,
         The at least one activity,
         The at least one module,
         The at least one technical specification,
         The at least one cost,
         The at least one stage,
         The at least one resource, and
         The at least one template;

At least one computing device, wherein the at least one computing device is configured to the following:
Retrieving at least one technical specification from the memory storage,
   Wherein the retrieving of at least one technical specification comprises retrieving technical specification parameters,
      Wherein the technical specification parameters comprise the following:
         The at least one RDM,
         The at least one data element,
         The at least one rule,
         The at least one activity,
         The at least one module,
         The at least one technical specification,
         The at least one cost,
         The at least one stage,
         The at least one physical resource, and
         The at least one data element;
Optimizing technical specification deployment planning based on analyzing of the technical specification parameters,
Optimizing cost based on the analysis of the technical specification deployment parameters,
Optimizing allocation of resources based on analyzing of the technical specification deployment parameters,
   Wherein optimizing allocation of resources comprises optimizing allocation of at least one of the following:
      The at least one physical resource,
      The at least one module,
      The at least one rule,
      The at least one human resource assignment,
      The at least one time requirement,
      The at least one RDM, and
      A technical specification deployment timeline based on the at least one stage,
   Wherein optimizing allocation of resources comprises further comprises optimizing performed by an artificial intelligence,
      Wherein optimizing performed by an artificial intelligence comprises training artificial intelligence with the at least one of completed technical specification deployments, ongoing deployments, user correction input,
Performing duties of at least one of the following roles:
   An agent,
   A Deployment monitor,
   A Service representative,
   A Support agent, and
   A Technician.

The following disclose various Aspects of the present disclosure. The various Aspects are not to be construed as patent claims unless the language of the Aspect appears as a patent claim. The Aspects describe various non-limiting embodiments of the present disclosure.

Embodiments of the present disclosure may be employed on or more, or none, of the aforementioned modules, to deliver a plurality of aspects of the present disclosure. The aspects may include, but are not limited to:
1. A platform configured for business operational lifecycle, the platform comprising:
   A memory storage system, wherein the memory storage system is configured to save and retrieve the following:
   At least one RDM,
      At least one data element,
      wherein each data element within at least one data element is associated with at least one RDM from the at least one RDM,
      wherein each data element within at least one data element is associated with at least one RDM,
   At least one time requirement,
      wherein each time requirement within at least one time requirement is associated with at least one RDM from the at least one RDM,
   At least one resource assignment,
      wherein each resource assignment, within at least one resource assignment, is associated with at least one RDM from the at least one RDM,
   At least one rule,
      At least one activity,
      Wherein each activity comprises one of at least one deliverable and at least one technical specification deployment plan,
      Wherein each activity comprises at least one activity parameter,
         Wherein each activity parameter in the at least one activity parameter comprises one of the following:
            time requirement,
            human resource assignment,
      At least one module,
      wherein each module within at least one module is associated with at least one RDM from the at least one RDM and at least one rule from the at least one rule,
   At least one physical resource,
      wherein each physical resource within at least one physical resource is associated with at least one RDM from the at least one RDM,
      At least one stage,
      wherein each stage within at least one stage is associated with at least one RDM from the at least one RDM and at least one rule from the at least one rule,
      At least one technical specification deployment,
      wherein each technical specification deployment within at least one technical specification deployment is associated with at least one RDM from the at least one RDM,
      wherein each technical specification deployment within at least one technical specification deployment is associated with at least one stage,
      wherein each technical specification deployment within at least one technical specification deployment is associated with at least one cost,
      wherein each technical specification deployment within at least one technical specification deployment is associated with at least one module,
      wherein each technical specification deployment within at least one technical specification deployment is associated with at least one activity, and
      wherein each technical specification deployment within at least one technical specification deployment is associated with at least one data element from the at least one RDM,
      At least one resource,
      wherein each resource within at least one resource is associated with at least one RDM from the at least one RDM,
      At least one template,
      wherein each template within at least one template comprises metadata associated with at least one of the following:
         The at least one RDM,
      The at least one data element,
      The at least one rule,
      The at least one activity,
      The at least one module,
      The at least one technical specification,
      The at least one resource, and
      The at least one template.

### VII. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the present disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system comprising:
a memory storage communicatively coupled with a processing unit; and
the processing unit coupled to the memory storage, the processing unit being operative to perform the following:
receive at least one user selection from at least one of the following:
at least one of a plurality of preconfigured specification parameters, and
a grouping of the plurality of preconfigured specification parameters,
identify at least one resource based on the received at least one user selection, the at least one resource comprising at least one of the following:
software information,
license information,
service provider information,
technical components, and
implementation parameters,
generate at least one deployment rule, the at least one deployment rule comprising:
customizing of at least one user selection of the plurality of preconfigured specification parameters,
customizing of at least one of a deployment cost analysis, and
providing a deployment strategy to the user,
generate a technical specification, the technical specification comprising at least one technical requirement defined by the following:
the at least one user selection of the plurality of preconfigured specification parameters, and
the at least one deployment rule,
wherein the at least one technical requirement comprises at least one of the following:
a temporal parameter,
a resource projection,
a machine activity, and
a software activity,
generate the deployment cost analysis of the technical specification, and
deploy the technical specification comprising the at least one technical requirement,
wherein the generating of the technical specification comprises processing the at least one user selection via applying each of the at least one deployment rule to each of the at least one user selection.

2. The system of claim 1, further operative to:
generate at least one activity from the technical specification, wherein the generating of the at least one activity comprises calculating at least one activity parameter using values including the following:
at least one external service agreement;
at least one time requirement; and
at least one rule.

3. The system of claim 1, wherein the processing unit is further operative to:
retrieve at least one module, wherein retrieving the at least one module is operative to perform the following:
identify at least one module for retrieval based on the received at least one user selection and the at least one deployment rule; and
retrieve the identified at least one module.

4. The system of claim 1, further operative to allocate the at least one resource.

5. The system of claim 4, further operative to update, based on the allocation of the at least one resource, the deployment cost analysis of the technical specification.

6. The system of claim 4, further operative to update, based on the allocation of the at least one resource, the deploying of the technical specification.

7. The system of claim 1, further operative to:
associate the at least one of the plurality of preconfigured specification parameters with the technical specification, and
store the technical specification and the at least one of the plurality of preconfigured specification parameters in the memory storage.

8. The system of claim 1, further operative to retrieve from the memory storage an Artificial Intelligence (AI) submodule.

9. The system of claim 8, wherein the AI submodule is configured to optimize the deploying of the technical specification.

10. The system of claim 1, further operative to generate a deliverable based on the technical specification.

11. A method comprising:
receiving at least one user selection of at least one of the following:
at least one of a plurality of preconfigured specification parameters , and
a grouping of the plurality of preconfigured specification parameters;
identifying at least one resource based on the received at least one user selection, the at least one resource comprising at least one of the following:
software information,
license information,
service provider information,
technical components, and
implementation parameters,
generating at least one deployment rule comprising:
customizing of at least one user selection of the plurality of preconfigured specification parameters,
customizing of at least one of a deployment cost analysis, and
providing a deployment strategy to the user;
generating a technical specification, the technical specification comprising at least one technical requirement defined by the following:
the at least one user selection of the plurality of preconfigured specification parameters, and
the at least one deployment rule,
wherein the at least one technical requirement comprises at least one of the following:
a temporal parameter,
a resource projection,
a machine activity, and
a software activity,
generating the deployment cost analysis of the technical specification, and
deploying the technical specification comprising the at least one technical requirement,
wherein generating the technical specification comprises processing the at least one user selection via applying each of the at least one deployment rule to each of the at least one user selection.

12. The method of claim 11, further comprising:
generating at least one activity from the technical specification, wherein generating the at least one activity comprises calculating at least one activity parameter using values including the following:
at least one external service agreement;
at least one time requirement; and
at least one rule.

13. The method of claim 11, further comprising:
retrieving at least one module from the memory storage, wherein retrieving the at least one module comprises the following:
identifying at least one module for retrieval based on the received at least one user selection and the at least one deployment rule; and
retrieving the identified at least one module.

14. The method of claim 11, further comprising allocating the at least one resource.

15. The method of claim 14, further comprising updating, based on the allocation of the at least one resource, the deployment cost analysis of the technical specification.

16. The method of claim 14, further comprising updating, based on the allocation of the at least one resource, the deploying of the technical specification.

17. The method of claim 11, further comprising:
associating the at least one of the plurality preconfigured specification parameters with the technical specification; and
storing the technical specification and the at least one of the plurality preconfigured specification parameters in the memory storage.

18. The method of claim 11, further comprising retrieving from the memory storage an Artificial Intelligence (AI) submodule.

19. The method of claim 18, further comprising optimizing, via the AI submodule, the deploying of the technical specification.

20. The method of claim 11, further comprising generating a deliverable based on the technical specification.
